(19) United States
(12) Patent Application Publication
(10) Pub. No.: US 2005/0144265 A1
(43) Pub. Date: Jun. 30, 2005

(54) Data collection system using remotely configurable scripting

(76) Inventors: James Roe-Smith, South Australia (AU); Craig Stallan, South Australia (AU)

Correspondence Address: Klauber & Jackson, Continental Plaza, 411 Hackensack Avenue, Hackensack, NJ, 07601, US

(21) Appl. No.: 10/511,653

(22) PCT Filed: Apr. 16, 2003
(86) PCT No.: PCT/AU03/00456

(30) Foreign Application Priority Data
Apr. 16, 2002 (AU) PS 1738

(51) Int. Cl. G06F 15/173; G06F 15/16; G06F 9/46

(52) U.S. Cl. 709/223; 709/218; 715/513; 719/315

(57) ABSTRACT

A digital data collection system is disclosed that provides the ability to configure, re-configure and append software and functionality to remote computer installations regardless of the location or Windows™ operating system of the remote computer installation. The data collection system creates two or more objects in a computer system at a location having a processor and memory. The system collects data from the computer or another computer at the location and transmits data to a computer at a remote location. The system has a central core system comprising a central core system object and a form object and a configuration file. The form object creates the central core system object in the computer memory, which reads the configuration file to execute and delegate commands within the configuration file including the creation of data control objects. There are one or more data control objects created by the central core system, wherein all said objects have a common data interface for the exchange of commands and data between objects and a predetermined functional element. There is access to a configuration file and one or more functional libraries, wherein the data control object created includes a transmit object for exchanging data with the computer at the remote location.

### TECHNICAL FIELD

This invention relates to a digital data collection system that provides the ability to configure, re-configure and append software and functionality to remote computer installations regardless of the location or Windows™ operating system of the remote computer installation.

### BACKGROUND

Issues and questions surrounding the problem of remote data collection include:
How will specific data be retrieved?
When is data to be retrieved?
How is data to be sent?
When is data to be sent?
How can the collection system be modified remotely?
How are the solutions to these issues going to be controlled?
How can the collection system functions be customized?
How can new functions (i.e. Dynamic Link Libraries) be added?
How can old functions be replaced?
How can new data sources be added?

Any solution to the above problems and issues should preferably not significantly impact on the operation of the remote machine from which the data is requested.

Current systems address some of the abovementioned needs and issues associated with remote data collection. A common approach is to write a single software application that is:
Hard-coded to connect to a specific data source
Hard-coded to connect to a temporary database
Hard-coded to transmit data

Such an approach is typically taken because software is not available that is compatible with all the different remote systems. Different Operating Systems, different databases and different communication protocols make every solution unique.

Subsequently, should any of the code embedded in the hard-coded program need to be changed after installation, a rewrite and complete re-compilation of the program and an on-site installation is typically required. Changes arise for many reasons but they could be as simple as a change in a directory or as problematic as a change in the database.

The following universal needs are indicative of the shortcomings identified by current data collection systems:
Retrieval of data from multiple remote locations
To configure, re-configure and append installations remotely
Non-reliance upon and independence from a particular database technology or data source type used at the remote location

It is an aim of this invention to provide a data collection system that reduces or eliminates some if not all of the shortcomings of the prior art or at least provides an alternative approach.

### BRIEF DESCRIPTION OF THE INVENTION

In a broad aspect of the invention is a data collection system for the creation of two or more objects in a computer system at a location having a processor and memory, the system collects data from the computer or another computer at the location and transmits data to a computer at a remote location, the system having
a central core system comprising a central core system object and a form object and a configuration file, wherein said form object creates the central core system object in said computer memory and which reads said configuration file to execute and delegate commands within the configuration file including the creation of data control objects,
one or more data control objects created by said central core system, wherein all said objects have a common data interface for the exchange of commands and data between objects and a predetermined functional element that has access to a configuration file and one or more functional libraries, wherein a said data control object created includes a transmit object for exchanging data with said computer at said remote location.

In a further aspect of the invention the data collection system creates an installer object for receiving encoded files from said computer at said remote location and decoding the file and installing the decoded file in a function library for use by one or more objects in said data collection system.

In a yet further aspect of the invention the data collection system creates a timer object for storing commands to be executed by other objects a predetermined count from a reference count.

In another aspect of the invention the data collection system creates new objects or updates objects using data supplied by said computer at a remote location.

In a further aspect of the invention the timer object transmits to said computer at said remote location a signal indicating that said data collection system is able to transmit data to it.

In a yet further aspect of the invention the data collection system creates a store object that temporarily stores data in a database and manages said stored data before it is transmitted to said computer at a remote location.

In another aspect of the invention the store object bundles data in said data base or provides a predetermined bundle of data to another object or provides a list of bundles or deletes old data including bundles of data.

In an aspect of the invention the transmit object transmits bundles of data or lists of data to said computer at a remote location.

In another further aspect of the invention the data collection system creates a connector object for collecting data from said computer or another computer at said location of the data collection system.

In another aspect of the invention the data collected relates to alarms related to said computer or another computer at said location of the data collection system.

Another aspect according to prior aspects transmit, store and connector objects operate whenever a predetermined period of time has elapsed or a predetermined amount of data has been collected or when requested by said computer at a remote location.

Specific embodiments of the invention will now be described in some further detail with reference to and as illustrated in the accompanying figures. These embodiments are illustrative, and not meant to be restrictive of the scope of the invention. Suggestions and descriptions of other embodiments may be included but they may not be illustrated in the accompanying figures or alternatively features of the invention may be shown in the figures but not described in the specification.

### BRIEF DESCRIPTION OF THE FIGURES

FIG. 1 depicts a Data Collector System Object;

FIG. 2 depicts Data Collector System Communication Environment;

FIG. 3 depicts synchronous communication between the Objects;

FIG. 4 depicts asynchronous communication between the Objects;

FIG. 5 depicts the Data Collector core system;

FIG. 6 depicts the process of command execution

FIG. 7 depicts an example of the Central Core System Object (Glue) executing and passing commands at startup;

FIG. 8 depicts a Base system;

FIG. 9 depicts the process of establishing a heartbeat;

FIG. 10 depicts the installation of a new object by the Installer object;

FIG. 11 depicts the complete functional system;

FIG. 12 depicts the retrieval of data from the remote data source and storage of this data into the local database;

FIG. 13 depicts the sending of data bundles at set time intervals; and

FIG. 14 depicts the sending of data bundles at set capacity levels.

To better understand the invention, a preferred embodiment will now be described, but it will be realized that the invention is not to be confined or restricted to the precise nature of this embodiment.

### DETAILED DESCRIPTION OF AN EMBODIMENT OF THE INVENTION

The Data Collector System of the invention consists of independent, yet related, objects which together through the control imparted by one central object collects, stores and transmits data.

The central object communicates with, and co-ordinates the activity of all other objects by sending and receiving XML (extended Markup Language) commands. The use of XML commands is preferable. The use of multiple objects, which together perform separate functions through a common interface, enables the removal and addition of functionality. The use of XML scripting together with the ability to add and remove functionality enables remote configuration of the Data Collector System.

The Data Collector System is comprised of Communications Environment in which there is a collection of Data Collector System Objects, an XML Configuration File, the Common Function Library, and a Windows Application (which hosts the Collector Objects). Interaction with each other and the outside environment (e.g. Remote Data Sources, Internet, Data Store/s) via the Data Collector System objects.

Data Collector System Communication Interface

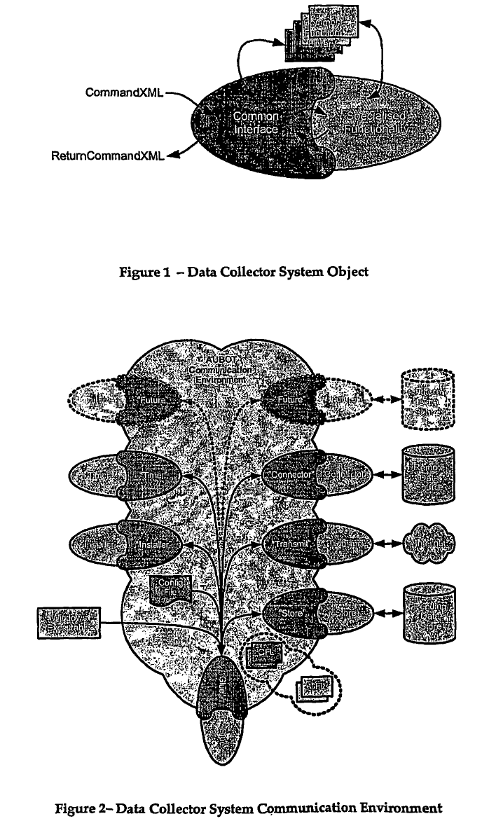

Each Data Collector System Object within the Data Collector System is comprised of two distinct parts depicted in FIG. 1.
Common Interface
Specialized Functionality

The Common Function Library (CFL) is accessible to all Data Collector System Objects and contains standard routines. Both the Common Interface (CI) and Specialized Functionality (SF) address the CFL yet both access a distinctly separate set of sections of the library, that is they do not share functionality within the library. The arrangement depicted is only preferable, as it would be quite acceptable to provide the CI and SF with separate CFLs.

Common Interface

The Common Interface defines a limited and fixed set of methods/properties that each Object knows about. These are:

| | |
|---|---|
| SetUp | Error |
| ShutDown | IsHealthy |
| CommandXML | Ping |
| ReturnCommandXML | |

The properties CommandXML and ReturnCommandXML provide the functionality to pass XML commands between two Objects. FIG. 1 illustrates how the Data Collector System Object is comprised of the Common Interface and Specialized Functionality parts, as well as the flow in and out of the XML commands.

An XML-Command is a single XML document, which contains a top-level command and optionally a series of sub-commands. The top-level command with sub-commands form a to-do list. The associated Object executes the top-level command first, then the first sub-command is promoted to be the top-level command and its associated Object executes it. Execution continues until all sub-commands are promoted and executed.

On receipt of an XML command, the Common Interface using the Command XML property performs the following:
1. Inspects the XML to retrieve the command and any associated parameters.
2. Calls the relevant specialized functionality that implements the command (passing parameters if required)
3. If the call returns any XML data, it adds this data to the current command.
4. Returns the (possibly updated) command to whence it came, in general the Central Core System Object (Glue), via the ReturnCommandXML property.
5. Central Core System Object (Glue) promotes the first sub-command, if one exists, and if so repeats steps 1 to 5.
   Specialized Functionality

The Specialized Functionality part of the Data Collector System Object, under instruction from the Common Interface part, performs specific operations such as connecting to a database to retrieve values (Connector) or to the Internet to send information (Transmit). A component may have more than one specialized function.

In this embodiment Component Object Model (COM+) is used to implement the functionality of this part of the component, and as such, it is comprised of simple procedural calls, which may or may not return data. If it does return data, it does so as valid XML.

The Component Object Model (COM) is a way for software components to communicate with each other. However, COM is a particular instantiation of a generic object orientated communication language. COM is a binary and network standard that allows any two components to communicate regardless of what machine they're running on (as long as the machines are connected), what operating systems the machines are running (as long as it supports COM), and what language the components are written in. COM further provides location transparency: it doesn't matter whether the other components are in-process DLLs, local EXEs, or components located on some other machine.

A feature of COM is that there are three types of objects supported: in process (DLL), local (EXE in separate process on the same machine), and remote (DLL or EXE on a different machine via Distributed COM, or DCOM). Code written using COM components can be done without even knowing what type of COM object is used, so the exact same code can be used to hook up to an in-process, local, or remote object. COM hooks to the correct object by looking for the objects'Class ID in the registry—and the registry entries tell COM which type or types of objects are available. COM does the rest, including starting processes and communicating over the network.

Whether the language used to develop the objects is Visual Basic, Java, C++, Delphi, or some other COM-compatible language or some generic or specific object orientated communication language, the objects written will be usable on a local machine or remotely without rebuilding the object or the object's clients. This is because of the functionality of the object orientated language and in this embodiment COM and DCOM. It is also possible for objects to run on platforms other than Windows as COM is ported to other platforms.

Data Collector System Communication Environment

Any object that possesses a Common Interface may be added to the Data Collector System.

The Data Collector System Communications Environment comprises one or more Data Collector System Objects and respective Common Function Libraries, plus a Configuration File and a Windows Executable. This is depicted in FIG. 2.

Intra-System Communication Protocol

Currently, Windows'COM+ technology is used to facilitate communication between Objects. Whilst it is necessary to communication between Objects, it is not necessary to use COM+. Other protocols, such as EP, MSMQ or SMTP, may be used.

Synchronous vs. Asynchronous Communication

Currently, communication between the Objects is synchronous, thus only the Object within the system may execute an XML-Command (containing top-level & sub-commands) at any moment in time. New XML-Commands can only begin execution when all Objects become idle.

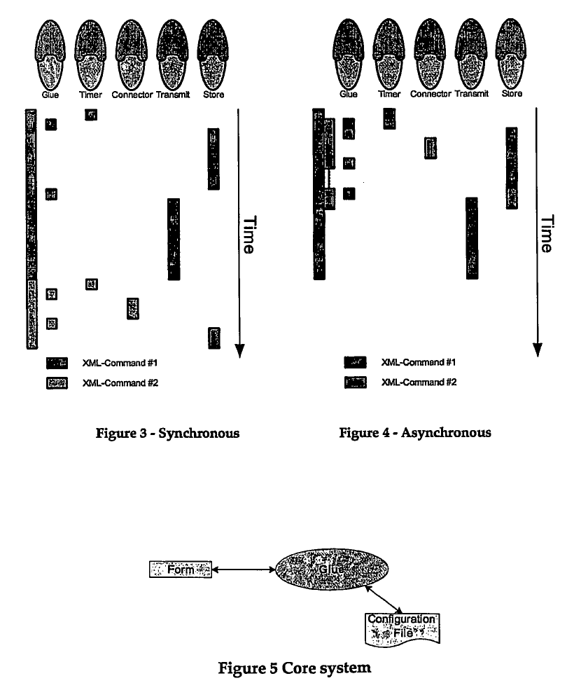

Despite this current implementation, communication between Objects may be configured so that it is asynchronous. Therefore, whilst an System Object cannot execute two commands simultaneously, the system as a whole will be able to execute commands asynchronously because distinct objects would be able to execute distinct commands simultaneously. FIG. 3-Synchronous and FIG. 4 Asynchronous show this relationship.

The Data Collector System Objects accommodate either synchronous or asynchronous communications.

The Data Collector System preferably uses:
An XML scripting language to co-ordinate object activities.
A central object manages the activities of independent yet related objects.
The Data Collector System is remotely configurable once a base system is installed as will be illustrated later in this specification.

As the arrangement of objects is completely configurable and re-configurable, the number and type of objects present within the Data Collector System at any one time can vary.

Three distinct types of systems that make up a Data Collector System, each comprised of different collection of object are used:
Core system
Base system
Functional system
   Core System

The core system is comprised of the essential objects necessary for the creation of all other objects. The core system alone creates the objects necessary to form the base system.

Base System

The base system supports, and is essential for, remote configuration such that an entire Data Collector System may be built and maintained remotely.

Functional System

The functional system addresses many of the issues concerning how the remote data is to be collected and when.

The advantages of remote data retrieval include:
Data from multiple remote sites can be brought together
System is completely remotely configurable
Upgrades can be implemented “on the run”
   Core System

The Data Collector System core system supports the following:
Creation of new objects to form the base system
   Objects

The Core System of the Data Collector System, depicted in FIG. 5, is comprised of the following objects:
Form
(Central Core System Object herein referred to as Glue)
Configuration File
   Form

The Form object creates and holds Glue in memory. Form also contains a physical timer and sends regular time signals (“pings”) to Glue. Once new objects are created, Glue in turn “pings” these objects. The ping is used for internal timings if required, however, is mostly ignored. The Timer object is the main object that utilizes the ping.

Glue

Glue binds the core system together and it in turn holds all objects of the Data Collector System in memory. It is responsible for creating all other objects of the Data Collector System and for controlling the activities of these objects through the use of XML commands. Glue executes commands addressed to it and passes commands addressed to other objects to those objects for execution. Once an object (including Glue) has executed a command, that command is passed back to Glue to indicate that execution is complete.

Glue-Commands are Placed in a Queue

When Glue receives a command to be executed by itself or by another object, it is placed at the end of a queue. The command at the head of the queue is called the current command and is the command currently being executed. Once execution of the current command is complete, Glue pops the next command off of the queue. This command becomes the current command.

Glue-Commands May Contain Sub-Commands

When the current command contains sub-commands, Glue directs the entire command including the sub-commands to the object to which the current command is addressed. This object then executes the current command and once completed sends the current command together with the subcommands back to Glue.

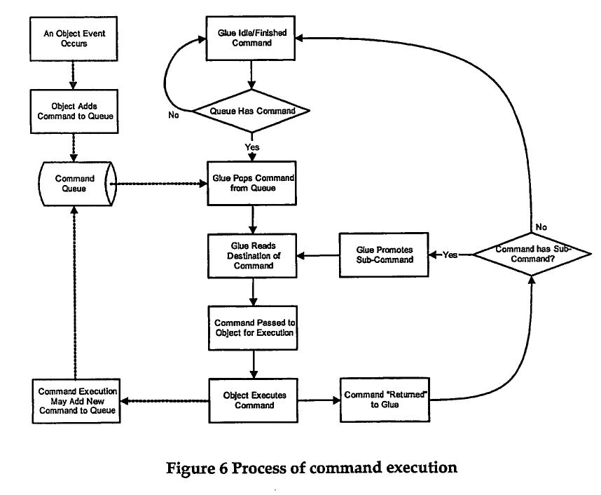

When Glue receives an executed command back from an object, Glue checks to see if the command contains sub-commands. If the command does contain sub-commands, Glue promotes the first sub-command as the current command. The current command, together with any remaining sub-commands, is then sent to the relevant object for execution. These processes re-iterate until all sub-commands have been executed (see FIG. 6). FIG. 6 demonstrates the involvement of Glue in the process of command execution.

Glue-Commands May Generate Other Commands

If the result of the execution of a command is additional commands needing to be executed, these additional commands are placed at the end of the queue within Glue, and are executed once the current and preceding commands have been executed.

Glue-Commands May Retain Data

Commands passed back to Glue may be accompanied by data. Data returned may be referenced by associated sub-commands through use of the following tag:
datatype=“<nameofdatatype>”

Once the execution of a command and its sub-commands is complete, any data returned and held is discarded and can not be used by any other commands in the queue.

Glue-CreateObject Command

Glue can execute a variety of commands, however, the most important command to be executed is the CreateObject command. The CreateObject command enables Glue to create all other independent, system-related objects. Once an object is created, Glue can send commands addressed to this object for execution.

Configuration File

The configuration file stores all commands to be executed on startup and contains a list of all required initialization data. Glue reads the configuration file on startup.

XML Events That Occur in the Core System

The main XML events that occur within the core system are:
1. Form creates Glue
2. Glue reads configuration file
3. Glue executes and delegates commands within configuration file, an example of which is to create objects
   <docmd object=“Glue” comnmnd=“CreateObject” createobject=“X”/>
      Creating an Object

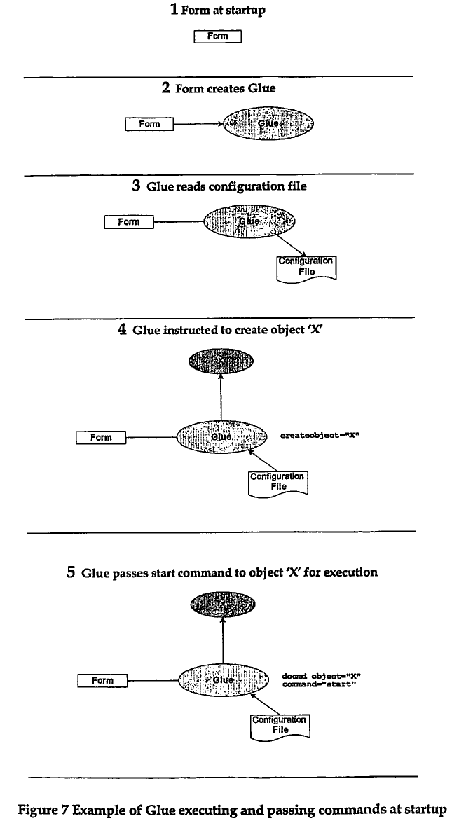

The CreateObject command can only be executed by Glue and is used to create all other independent and related objects. The Configuration File contains many CreateObject commands as this is read by Glue on startup and is necessary for the construction of the base system (see FIG. 7). FIG. 7 demonstrates the type of events, which occur on startup of the Data Collector System.

Base System

The Data Collector System base system supports the following:
1. Transmission of X data from and to the client-end
2. Creation of new objects

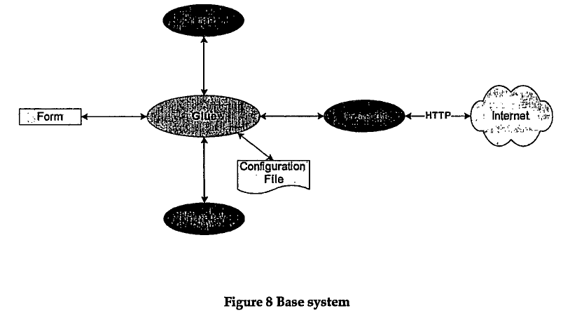

The Data Collector System base system, depicted in FIG. 8, is comprised of the core system plus the following three additional objects:
Transmit
Installer
Timer
   Transmit Object

The Transmit object sends and receives XML data to and from the Data Collector System server and as shown in FIG. 8 this is done via the Internet. The Transmit object includes the following functions:
1. Set up the URL addresses for the sending and receiving of data.
2. Send data to the Data Collector System server using the Dock command.
3. Notify the Data Collector System server that Collector is ‘alive’ using the Heartbeat command.
4. Optionally encrypts and compresses data.

On receipt of a heartbeat, the Data Collector System server sends back a command informing the Collector to either do nothing or to perform some action. The Data Collector System server can only send commands if a heartbeat is received.

Installer Object

The Installer object takes a data message that contains an encoded file and recreates it. If the file is of the type DLL (Dynamic Link Library) then the installer will register the library. This functionality enables new objects to be created and existing objects to be upgraded.

Timer Object and Command Store for Timed Events

The Timer object is responsible for storing commands to be executed at a set frequency. By synchronizing the frequency of an event with the system clock it is possible to execute commands at a specific time. Timer acts as a counter and sends stored commands at the appropriate times to Glue.

XML Events

The main XML events that occur within the base system are:

```
1. Setting up heartbeat URLs
  <docmd object=“Transmit” command=“SetURLs”
  heartbeaturl=http://www.camms.com.au/aubot/collector/heartbeat.asp
  dockurl=“http://www.camms.com.au/aubot/collector/dock.asp” />
2. Registering the heartbeat frequency
  <docmd object=“Timer” command=“Register” interval=“30”
  units=“Seconds”>
    <data type=“Command”>
  <docmd object=“Transmit” command=“HeartBeat” />
    </data>
  </docmd>
3. Installation of new objects
  <docmd object=“Installer” command=“Install” filename=“object.dll”>
  <data type=“DLL”>‘encoded DLL’</data>
  <data type=“SuccessCommand”>
  <docmd object=“Glue” command=“AddSystemData”>
    <docmd object=“Transmit” command=“Dock”
    datatype=“Success”/>
    <data type=“Success”>
                <message writeout=“object.dll installed
                successfully.”/>
    </data>
  </docmd>
  </data>
  <data type=“FailureCommand”>
  <docmd object=“Glue” command=“AddSystemData”>
    <docmd object=“Transmit” command=“Dock”
    datatype=“Failure”/>
    <data Type=“Failure”>
      <message writeout=“object.dll install failed.”/>
    </data>
  </docmd>
  </data>
    </docmd>
```

Establishing a Heartbeat

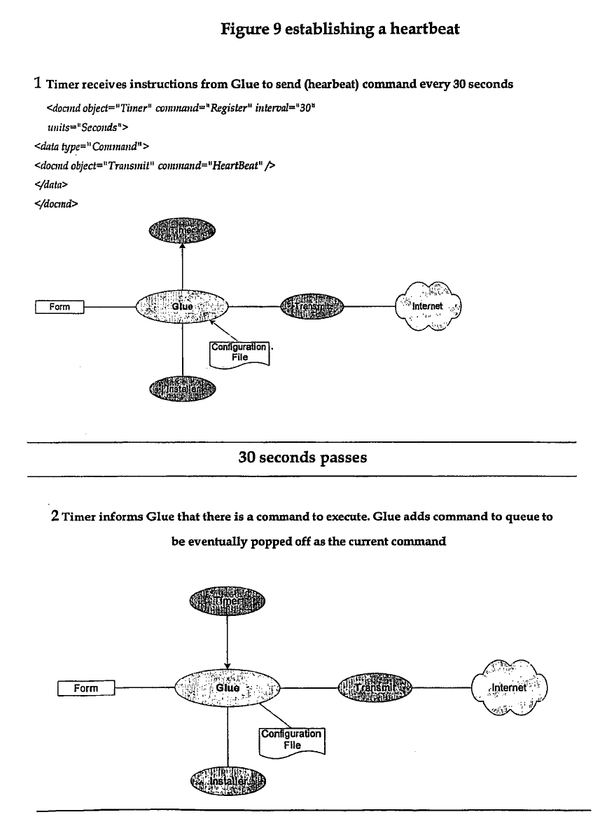

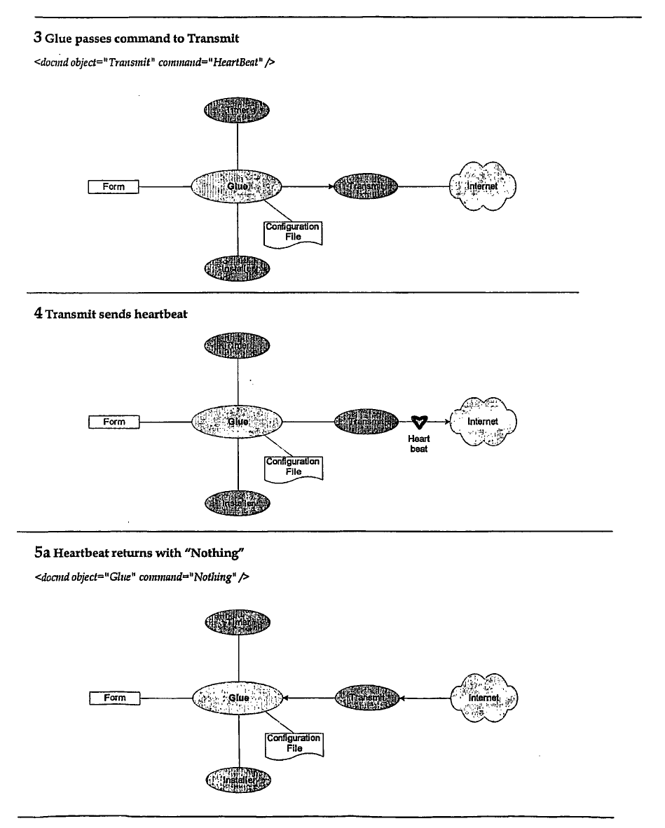

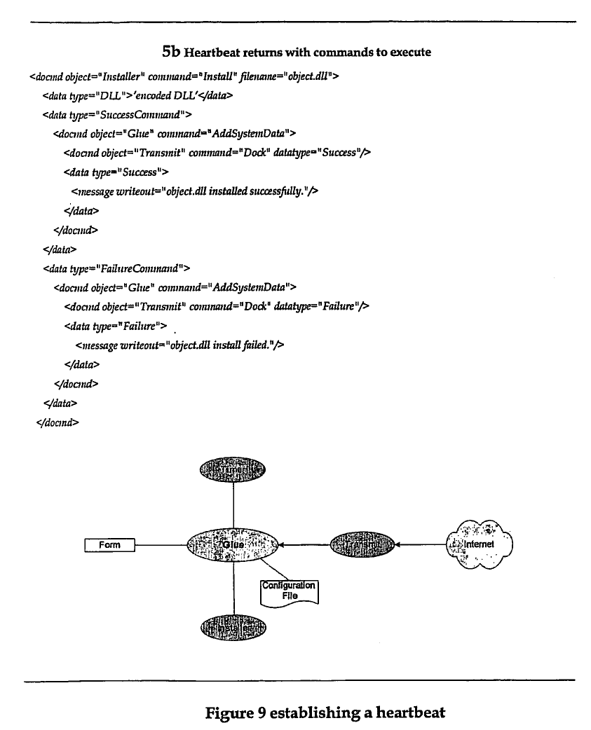

A heartbeat sent from the Transmit object informs that the Data Collector System is ‘alive’. The response from the central Data Collector System to a heartbeat is always to send a valid command, mostly a “do nothing” command. FIG. 9 demonstrates the process of establishing a heartbeat and at step 5A having a return do “Nothing” command and at step 5B having a return “Execute Command” for example Install a new .DLL file in the Configuration File (common of specific to an object).

Installing a New Object

The installation process requires 3 main components:
1. XML message containing installation instructions
2. Encoded DLL
3. Success and failure commands

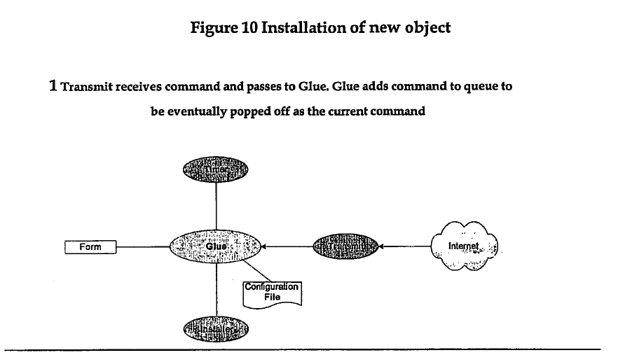

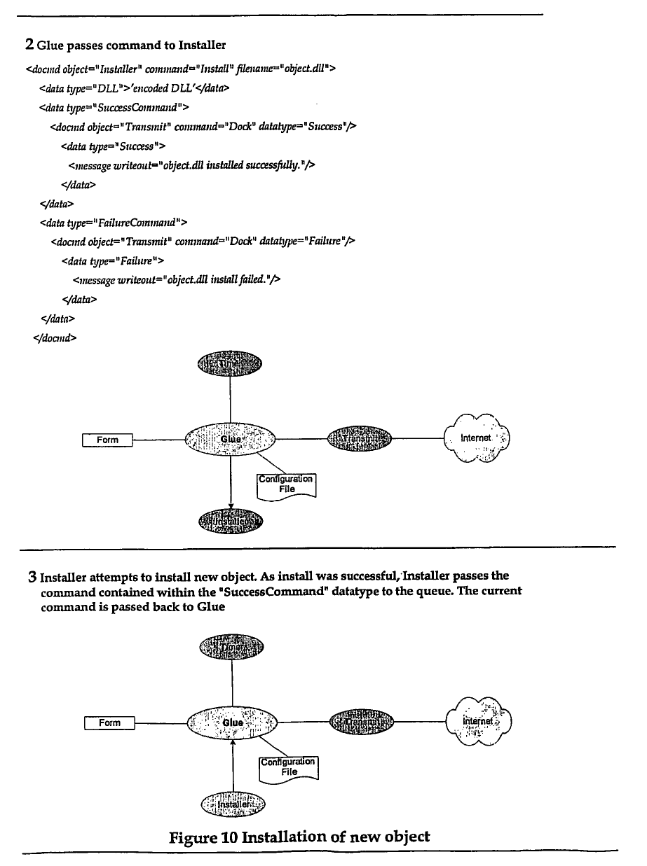

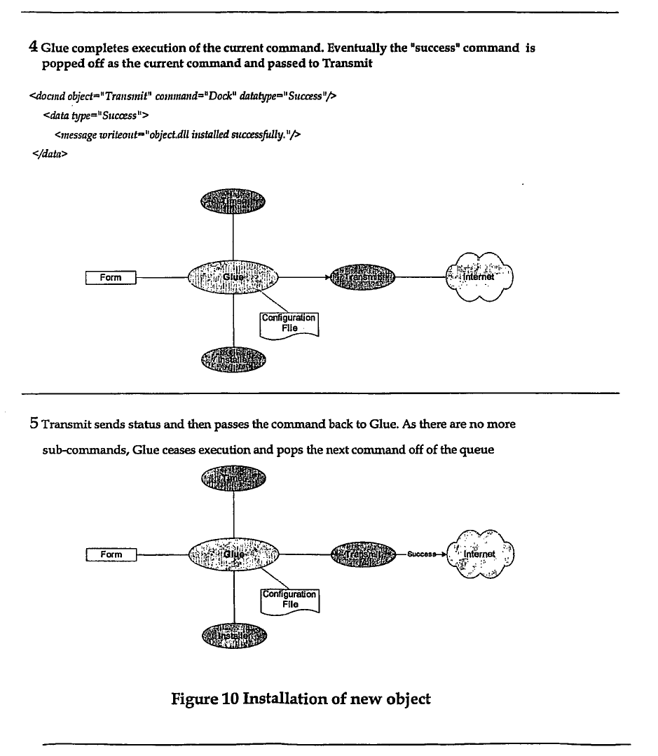

FIG. 10 demonstrates the installation of a new object by the Installer object.

Functional System

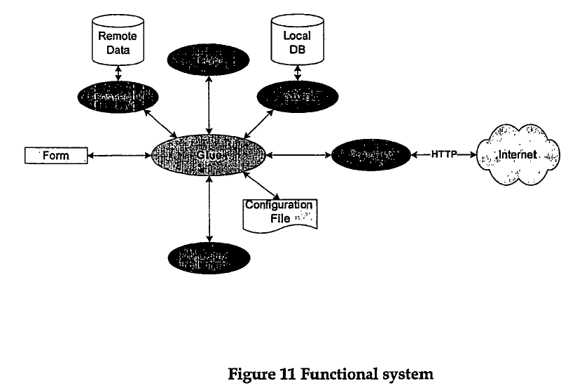

The Data Collector System functional system as depicted in FIG. 11 supports the following:
1. Retrieval of data
2. Storing of data
3. Bundling of data
4. Transmission of data
   Functional System Objects

The Data Collector functional system is comprised of the base system plus the following two objects:
Store
Connector
   Store

Store is the object that manages the local database. It is necessary to collect information before sending it. Thus the information is temporarily stored in a database. Store includes functions to add items, bundle items, get a list of bundles, delete bundles, get a specific bundle and get the current bundle. This allows store to completely control the contents of the database. Store executes a command based on an accumulated size of data stored trigger or count trigger. This allows the user to configure how the database is to be managed.

Connector

The Connector object is used to connect to the remote data source. Connector has the capability of requesting a list of data items from the data source, registering groups of data items and reading those registered groups. The object has the capability of collecting events created by the data source. These events allow the Collector object to register groups of alarms, thus when an alarm changes state, the Connector object is notified.

XML Events

The main XML events that occur within the functional system are:

```
1. Connector gets data from data source
  <docmd object=”Connector” command=”GetInfo”
  groupid=”accounts”/>
2. Store adds data to local database
  <docmd object=”Store” command=”AddItem” datatype=”Trend” />
3. Store bundles data
  <docmd object=”Store” command=”BundleCurrentItems”>
4. Store provides specific bundle
  <docmd object=”Store” command=”GetBundle” bundleid=”5”/>
5. Store provides list of bundles
  <docmd object=”Store” command=”GetBundleList”/>
6. Transmit sends bundle
  <docmd object=“Transmit” command=“Dock” datatype=“Bundle”/>
7. Transmit sends list of bundles
  <docmd object=”Transmit” command=”Dock”
  datatype=”BundleList”/>
8. Store deletes old bundles
  <docmd object=”Store” command=”DeleteOldBundles” olderthan=”7”
  units=”Days” />
```

The events listed above occur whenever one of the following occurs:

```
1. When a set period of time has passed
  <docmd object=“Timer” command=“Register” interval=“30”
units=“Minutes” synchtime=“00:00”>
  <data type=“Command”>
  <docmd object=“Store” command=“GetBundleList”>
  <docmd object=“Transmit” command=“Dock”
  datatype=“BundleList” />
            </docmd>
      </data>
  </docmd>
2. When the local database contains a certain number of items or has
  reached a certain size
  <docmd object=“Store” command=“SetTriggers” itemscount=“108”
  itemssizekbs=“800”>
      <data type=“Command”>
        <docmd object=“Store” command=“BundleCurrentItems”>
          <docmd object=“Glue” command=“AddSystemData” />
          <docmd object=“Transmit” command=“Dock”
          datatype=“Bundle”>
        </docmd>
      </data>
  </docmd>
```

3. When requested through Transmit
   Retrieving Data at Set Time Intervals

The Timer object may be used to set the frequency at which specific groups of data are to be read and stored.

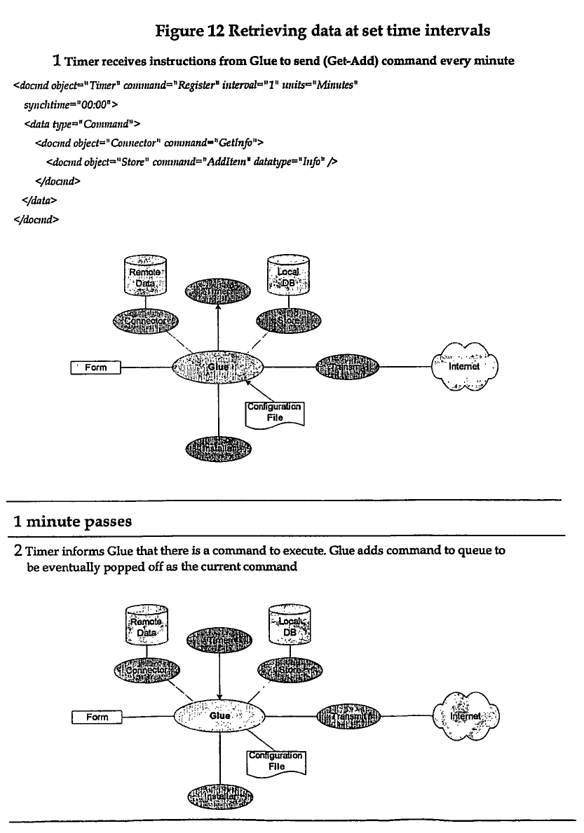

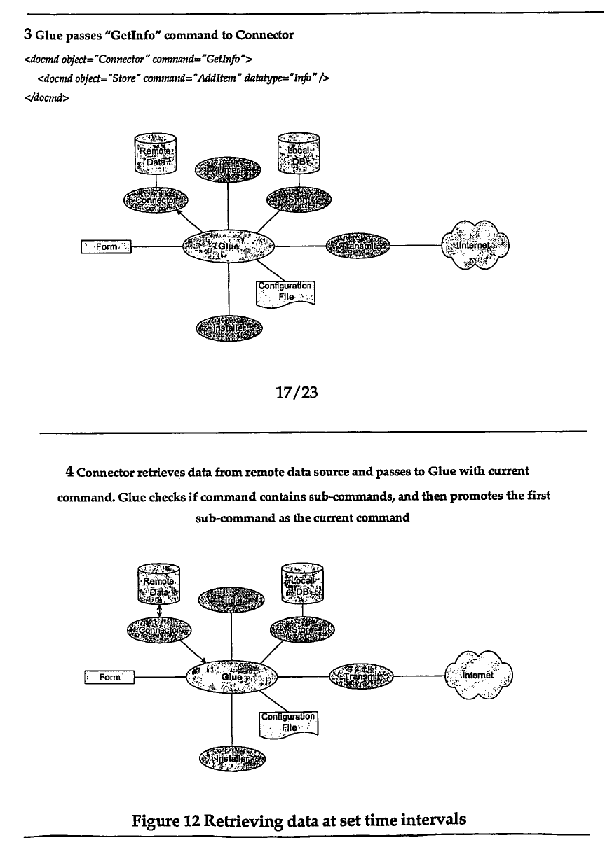

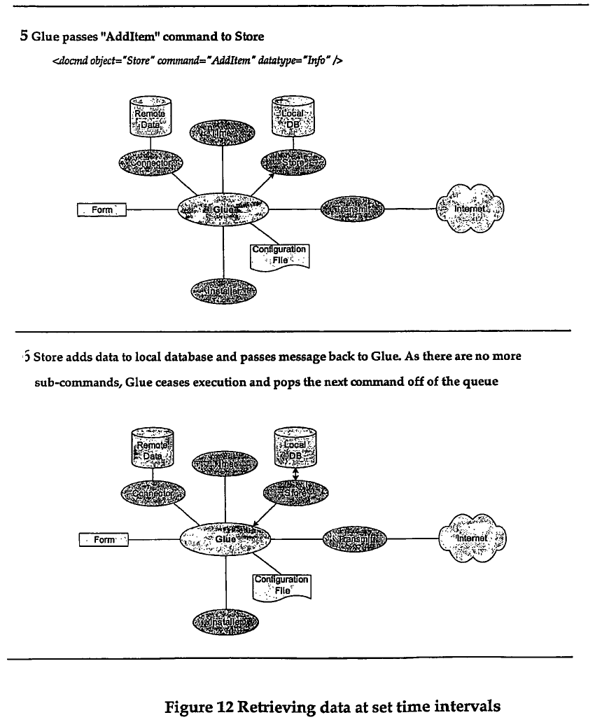

FIG. 12 demonstrates the retrieval of data from the remote data source and storage of this data into the local database.

Sending Data at Set Time Intervals

The Timer object may be used to set the frequency at which specific groups of data are to be sent.

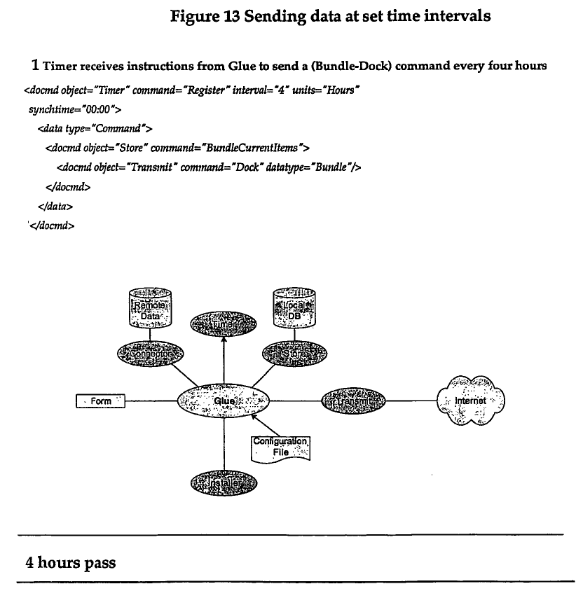

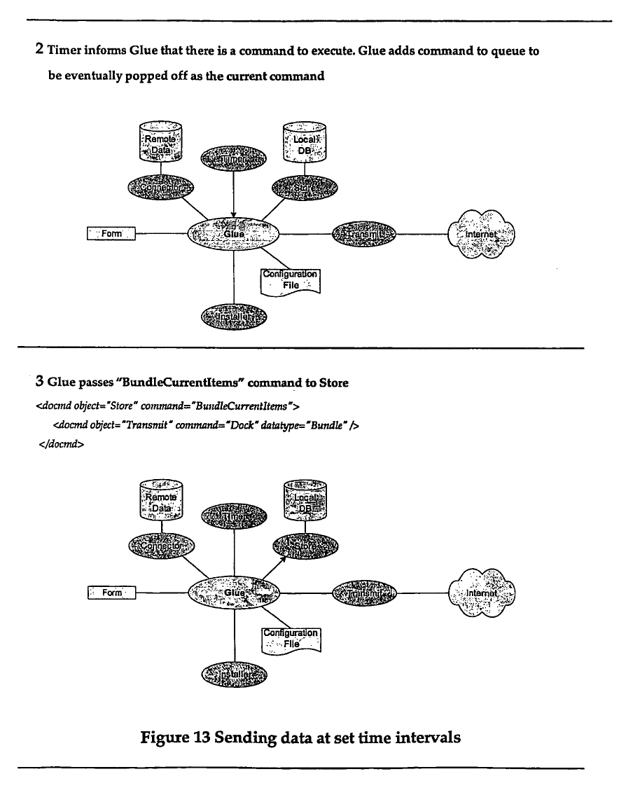

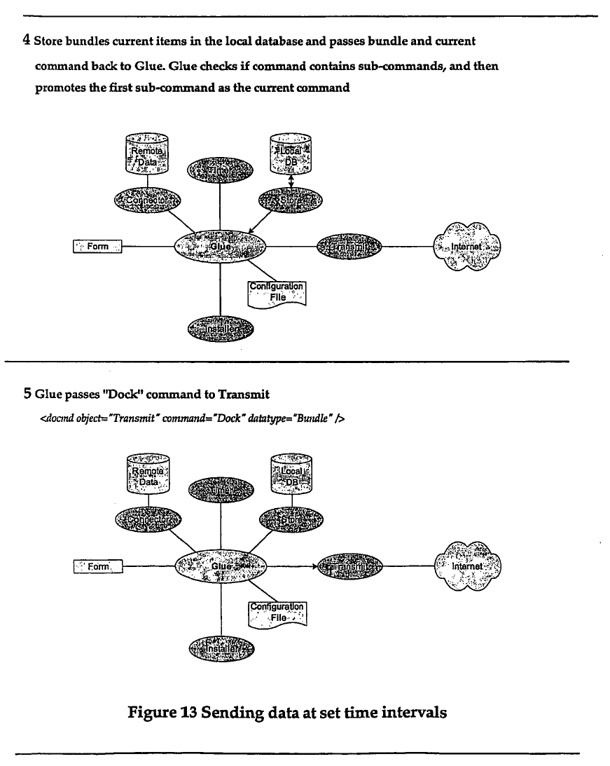

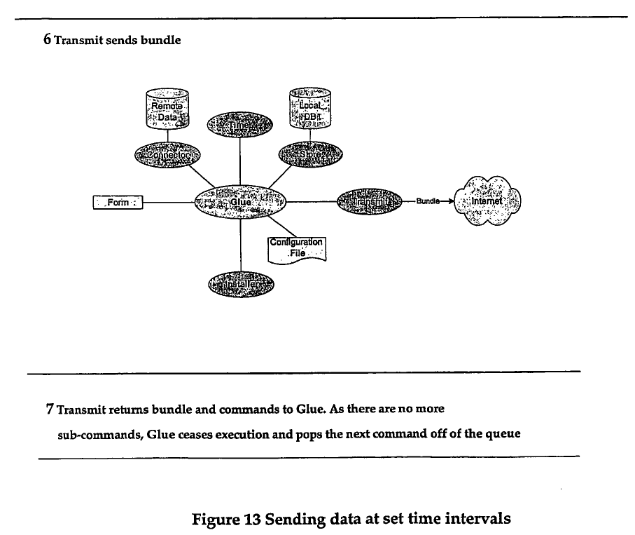

FIG. 13 demonstrates the sending of data bundles at set time intervals.

Sending Data at Set Capacity Levels

The Store object may be used to set a capacity level at which specific groups of data are to be sent.

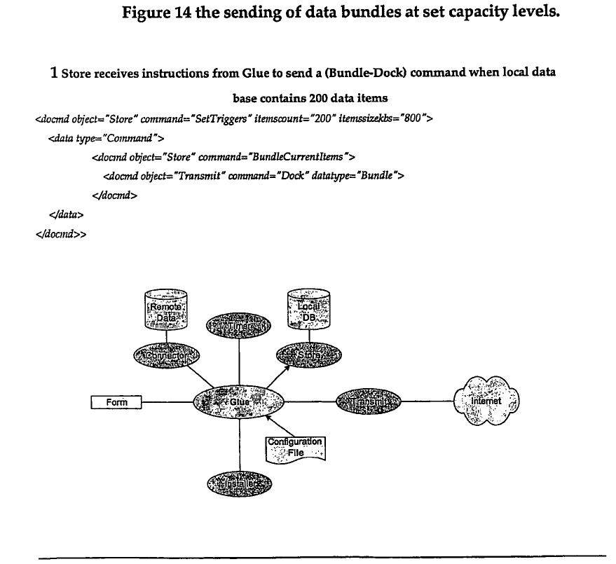

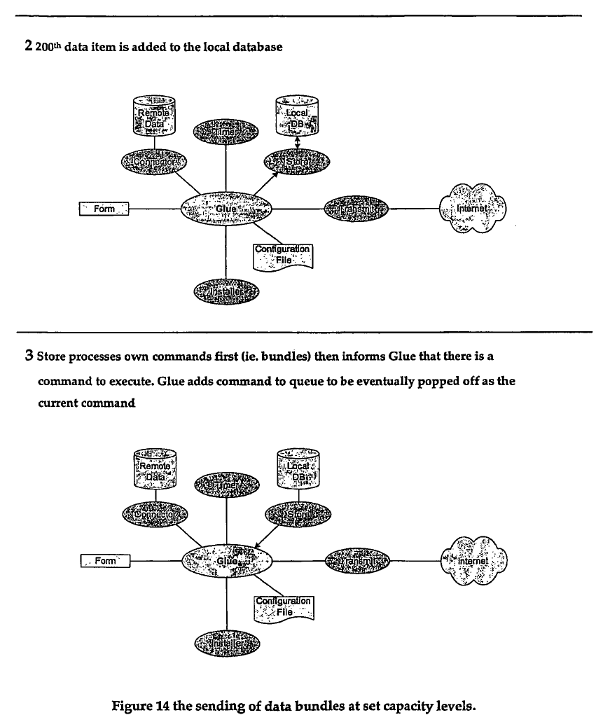

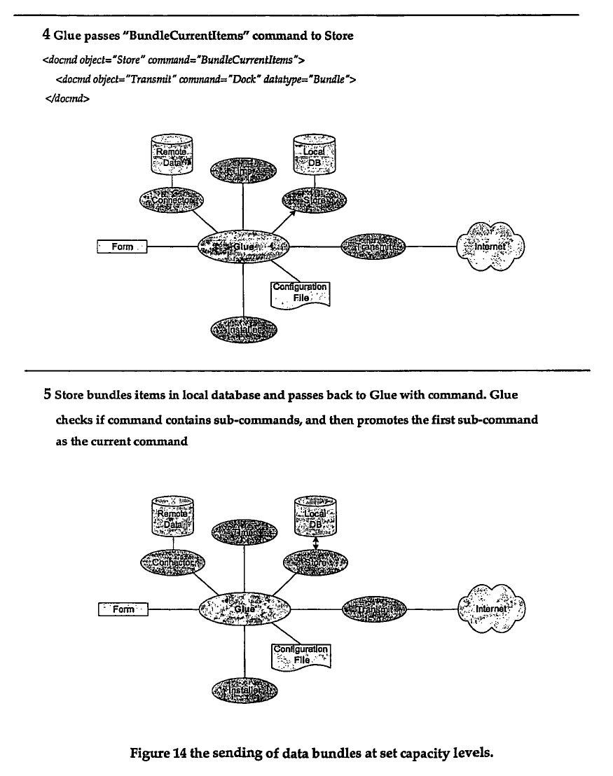

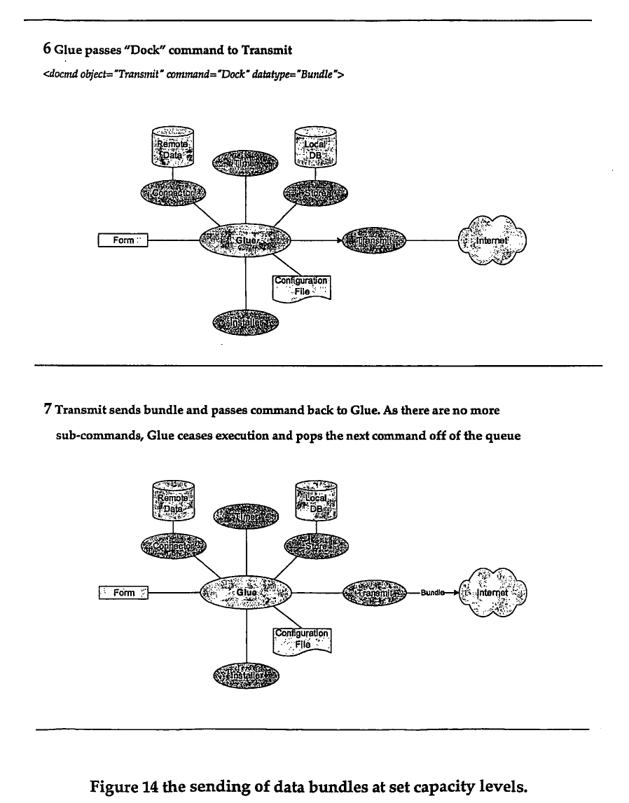

FIG. 14 demonstrates the sending of data bundles at set capacity levels.

Alternative Transmission Methods

The Data Collector System utilizes the HTTP protocol for the transmission of data as it provides the following advantages:
1. The firewall remains open at all times allowing for the continual sending and receiving of information.
2. Data can be passed in either direction. This enables the transmission of the remotely collected data, sending of “I'm alive” messages, retrieval of update commands and the passing back of status messages.
3. A connection can be either direct or made via a proxy server.
4. An intermediate remote server is not required.
5. The general user imperative for the HTTP protocol (Internet) to remain running at all times ensures that down time for communication between Data Collector System components is minimal.

Despite these advantages, the Data Collector System may be modified to accommodate the following alternative protocols:
MSMQ
FTP
SMTP
   MSMQ

MSMQ (Microsoft Message Queuing) is an effective way of communicating on LAN and WAN installations as it can be configured for guaranteed delivery.

FTP

FTP (File Transfer Protocol) enables the two-way transmission of files.

SMTP

SMTP (Simple Mail Transfer Protocol) enables the transmission of emails.

It will be appreciated by those skilled in the art, that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

1. A data collection system for the creation of two or more objects in a computer system at a location having a processor and memory, the system collects data from the computer or another computer at the location and transmits data to a computer at a remote location, the system having
a central core system comprising a central core system object and a form object and a configuration file, wherein said form object creates the central core system object in said computer memory and which reads-said configuration file to execute and delegate commands within the configuration file including the creation of data control objects,
one or more data control objects created by said central core system, wherein all said objects have a common data interface for the exchange of commands and data between objects and a predetermined functional element that has access to a configuration file and one or more functional libraries, wherein a said data control object created includes a transmit object for exchanging data with said computer at said remote location.

2. A data collection system according to claim 1 wherein said data collection system creates an installer object for receiving encoded files from said computer at said remote location and decoding the file and installing the decoded file in a function library for use by one or more objects in said data collection system.

3. A data collection system according to claim 1 wherein said data collection system creates a timer object for storing commands to be executed by other objects a predetermined count from a reference count.

4. A data collection system according to claim 2 wherein said data collection system creates new objects or updates objects using data supplied by said computer at a remote location.

5. A data collection system according to claim 3 wherein said timer object transmits to said computer at said remote location a signal indicating that said data collection system is able to transmit data to it.

6. A data collection system according to claim 4 wherein said data collection system creates a store object that temporarily stores data in a database and manages said stored data before it is transmitted to said computer at a remote location.

7. A data collection system according to claim 6 wherein said store object bundles data in said data base or provides a predetermined bundle of data to another object or provides a list of bundles or deletes old data including bundles of data.

8. A data collection system according to claim 1 wherein said transmit object transmits bundles of data or lists of data to said computer at a remote location.

9. A data collection system according to claim 4 wherein said data collection system creates a connector object for collecting data from said computer or another computer at said location of the data collection system.

10. A data collection system according to claim 8 wherein said data collected relates to alarms related to said computer or another computer at said location of the data collection system.

11. A data collection system according to claim 1, wherein said transmit, store and connector objects operate whenever a predetermined period of time has elapsed or a predetermined amount of data has been collected or when requested by said computer at a remote location.

12. A data collection system according to claim 1 wherein data is exchanged between said computers using HTTP.

13. A data collection system according to claim 1 wherein data is exchanged between said computers using MSMQ.

14. A data collection system according to claim 1 wherein data is exchanged between said computers using FTP.

15. A data collection system according to claim 1 wherein data is exchanged between said computers using SMTP.

16. A data collection system according to claim 1 wherein data is exchanged between objects using XML commands using Windows COM+.

17. A data collection system according to claim 1 wherein communication between objects is synchronous or asynchronous.

18. A data collection system according to claim 1 wherein said common data interface for the exchange of commands and data between objects includes one or more commands for setup, shutdown, error, Ishealthy, Ping, commandXML and ReturnCommandXML.
